(19) United States
(12) Patent Application Publication
(10) Pub. No.: US 2011/0036740 A1
(43) Pub. Date: Feb. 17, 2011

(54) HOUSING FOR PORTABLE ELECTRIC DEVICE AND METHOD FOR MANUFACTURING SAME

(75) Inventor: YU ZHANG, Shenzhen (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/771,200

(22) Filed: Apr. 30, 2010

(30) Foreign Application Priority Data
Aug. 12, 2009 (CN) 200910305546.7

(51) Int. Cl. B65D 73/00; B29C 45/14

(52) U.S. Cl. 206/477; 264/272.11

(57) ABSTRACT

A housing for portable electronic device is disclosed. The portable electronic device includes a base, a bracket fixed in the base and an embedding assembly. The embedding assembly is embedded into the base and fixedly connecting to the bracket. The invention also discloses a method for manufacturing the housing.

### BACK GROUND

1. Technical Field

The disclosure generally relates to a housing for portable electronic devices and a method for manufacturing the housing for portable electronic devices.

2. Description of Related Art

A housing for portable electronic devices is usually made of plastic material. The housing typically includes a molded battery chamber with an inserted metallic frame. However, during the molding process, the metallic frame cools faster than the plastic substrate, and therefore creates a large amount of internal stress that might deform the battery chamber.

Therefore, there is room for improvement within the art.

### BRIEF DESCRIPTION OF THE DRAWINGS

Many aspects of the housing for portable electronic device and method for manufacturing the same can be better understood with reference to the following drawings. These drawings are not necessarily drawn to scale, the emphasis instead being placed upon clearly illustrating the principles of the present housing for portable electronic device and method for manufacturing the same. Moreover, in the drawings like reference numerals designate corresponding sections throughout the several views.

FIG. 1 shows a perspective view of a housing for portable electronic device, in accordance with an exemplary embodiment.

FIG. 2 shows a partially exploded, perspective view of the housing for portable electronic device of FIG. 1 from another aspect.

FIG. 3 shows an enlarged perspective view of the bracket of the housing for portable electronic device of FIG. 1.

### DETAILED DESCRIPTION

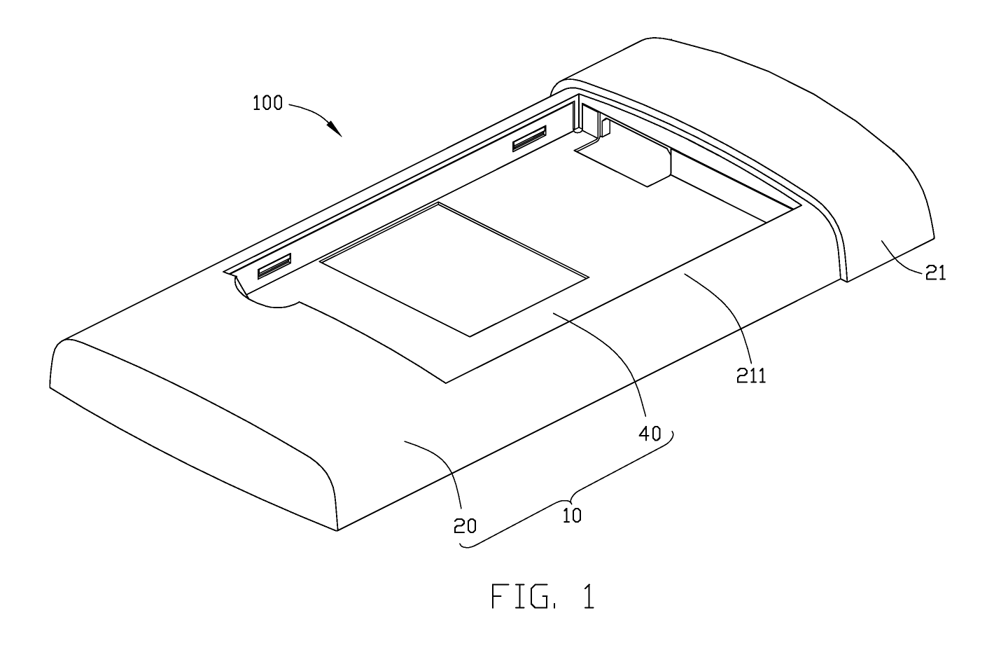

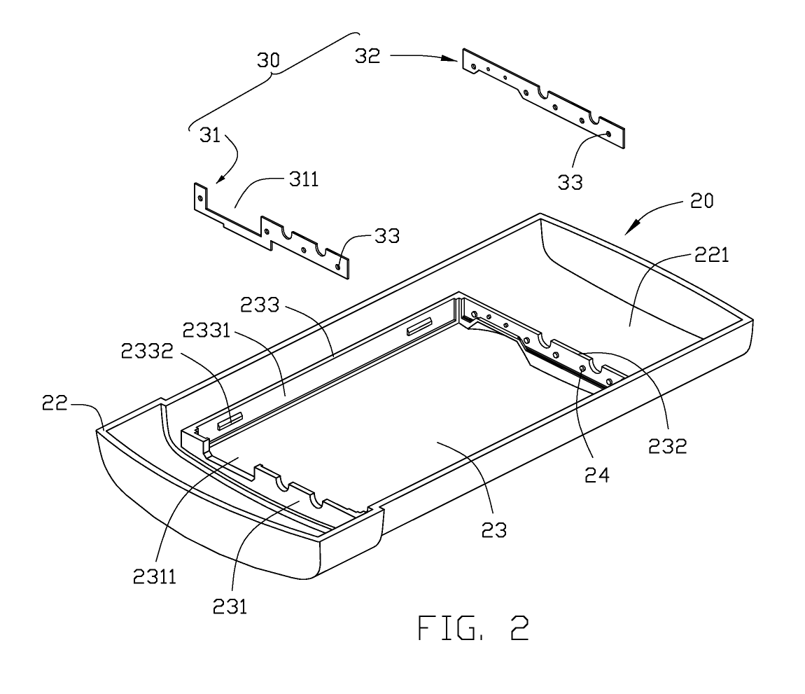

FIGS. 1 and 2 shows a housing 10 for a portable electronic device 100 such as mobile phone, personal digital assistant (PDA), digital camera, etc. The housing 10 for the portable electronic device 100 includes a base 20, an embedding assembly 30, and a bracket 40.

The base 20 may be substantially rectangular, and includes a front surface 21, a back surface 22 opposite to the front surface 21 and a chamber 23 defined therethrough. One end of the front surface 21 is recessed to form an assembling surface 211. The assembling surface 211 is configured for mounting a battery cover (not shown) to cover the chamber 23. The back surface 22 is recessed to form an assembling space 221 surrounding the chamber 23, and thus forms a first end wall 231, a second end wall 232 opposite to the first end wall 231, and two opposite side walls 233. The assembling space 221 is configured for assembling and accommodating the electronic elements (not shown) therein.

The chamber 23 may be substantially rectangular and defined through the assembling surface 211 of the front surface 21 and the back surface 22. The chamber 23 is configured for accommodating a battery (not shown) therein. The first end wall 231 includes a substantially rectangular through gap 2311. The first end wall 231 and the second end wall 231 both include a plurality of convex cylinders 24 protruding therefrom opposite to each other and configured for assembling the embedding assembly 30. The two side walls 233 each include a substantially rectangular slot 2331 recessed therein opposite to each other. Each slot 2331 receives two latching hooks 2322 spaced protruding from a bottom wall of the slot 2331.

The embedding assembly 30 can be made of stainless steel material, and includes a first sheet 31 and a second sheet 32. The first sheet 31 and the second sheet 32 are embedded into the corresponding first end wall 231 and the second end wall 232 respectively. The first sheet 31 defines a gap portion 311 therethrough corresponding to the gap 2311 of the first end wall 231. Each of the first sheet 31 and the second sheet 32 includes a plurality of through holes 33 defined therethrough corresponding to the convex cylinders 24 of the first end wall 231 and the second end wall 232.

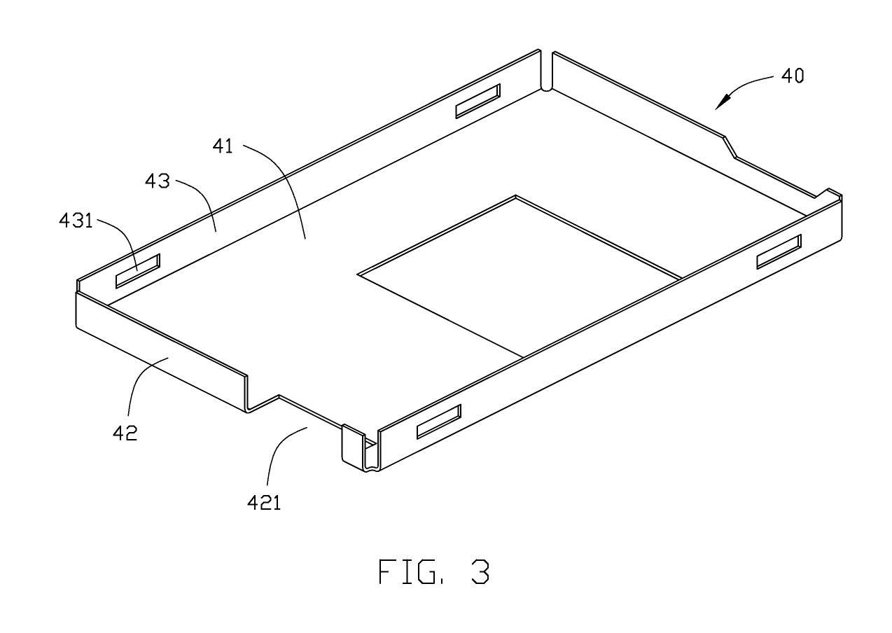

Referring to FIG. 3, the bracket 40 may be generally rectangular and assembled within the chamber 23 of the base 20. The bracket 40 includes a base wall 41, two transverse walls 42, and two opposite lateral walls 43. A notch 421 is defined through one of the two transverse walls 42 at the corner of the bracket 40 corresponding to the gap 2311 of the first end wall 231. The two transverse walls 42 of the bracket 40 are fixed to the first sheet 31 and second sheet 32 respectively. The two longitudinal lateral walls 43 are configured to be assembled and accommodated into the corresponding two slots 2331 of the two side walls 232 of the base 20. Each of the lateral walls 43 defines two spaced latching grooves 431 corresponding to the two latching hooks 2322 of the two side walls 232.

A method for manufacturing the housing 10 for the portable electronic device 100 includes steps as following.

A metallic sheet is punched, forming the first sheet 31, the second sheet 32, and the bracket 40. One or more plastic materials for the base 20 is selected from a group consisting of polyethylene (PE), polyamide (PA), polycarbonate (PC) composition, or acrylonitrile butadiene styrene (ABS).

The first sheet 31 and the second sheet 32 are inserted into an injection mold, and injected with molten plastic materials to form the base 20 integrally with the first sheet 31 and the second sheet 32. The convex cylinders 24 are formed on the first end wall 231 and the second end wall 232 of the base 20 passing through and fixing into the corresponding through holes 33 of the first sheet 31 and the second sheet 32 respectively. Thus, the first sheet 31 and the second sheet 32 are embedded into and are fixed to the corresponding first end wall 231 and the second end wall 232 of the base 20 respectively.

The bracket 40 is assembled into the chamber 23 of the base 20 with the longitudinal lateral walls 43 accommodated within the two slots 2331 and the latching hooks 2332 latching into the latching grooves 431, for strengthening the bracket 40. The transverse walls 42 of the bracket 40 are welded to the first sheet 31 and the second sheet 32.

It is to be understood, however, that even through numerous characteristics and advantages have been set forth in the foregoing description of embodiments, together with details of the structure and functions of the embodiments, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A housing for portable electronic device comprising:
a base;
a bracket fixed in the base; and
an embedding assembly embedded into the base and fixedly connecting to the bracket.

2. The housing for portable electronic device as claimed in claim 1, wherein the base includes a front surface, an opposite back surface and a chamber defined therethrough from front surface toward back surface; the bracket fixedly assembled within the chamber of the base.

3. The housing for portable electronic device as claimed in claim 2, wherein the one end of the front surface is recessed to form an assembling surface for mounting a battery cover thereon to envelop the chamber.

4. The housing for portable electronic device as claimed in claim 2, wherein the back surface is recessed to form an assembling space surrounding the chamber, thereby forming a first end wall, an opposite second end wall, and two opposite side walls.

5. The housing for portable electronic device as claimed in claim 4, wherein the first end wall and the second end wall both include a plurality of convex cylinders protruding therefrom opposite to each other; the embedding assembly includes a first sheet and a second sheet, the first sheet and the second sheet both includes a plurality of through holes defined therethrough corresponding to the convex cylinders; the first sheet and the second sheet are assembled to and embedded into the corresponding first end wall and the second end wall respectively.

6. The housing for portable electronic device as claimed in claim 4, wherein the first end wall includes a gap defined therethrough, the embedding assembly is made of stainless steel material and defines a gap portion therethrough corresponding to the gap of the first end wall; the embedding assembly is embedded into the first end wall.

7. The housing for portable electronic device as claimed in claim 5, wherein the two side walls both includes a slot recessed opposite to each other, the bracket includes two opposite longitudinal lateral walls configured to be assembled and accommodated into the corresponding two slots of the two side walls.

8. The housing for portable electronic device as claimed in claim 7, wherein the two longitudinal lateral walls both defines two latching grooves therein spaced, each slot includes two latching hooks spaced protruding from a bottom wall thereof and configured for latching into the corresponding two latching groove of each longitudinal lateral wall.

9. The housing for portable electronic device as claimed in claim 7, wherein the bracket further includes a base wall and two opposite transverse walls, a notch is defined at the corner of the bracket corresponding to the gap of the first end wall, the two transverse walls are welded to the first sheet and second sheet respectively.

10. A method for manufacturing the housing for portable electronic device comprising:
providing an embedding assembly and a bracket;
inserting the embedding assembly into an injection mold;
injecting molten plastic material into the injection mold to integrally form the base with the embedding assembly;
assembling the bracket into the base and fixing the bracket to the embedding assembly.

11. The method for manufacturing the housing for portable electronic device as claimed in claim 10, wherein the base includes a front surface, an opposite back surface and a chamber defined therethrough from front surface toward back surface; the bracket fixedly assembled within the chamber of the base.

12. The method for manufacturing the housing for portable electronic device as claimed in claim 11, wherein the chamber includes a first end wall, an opposite second end wall, and two opposite side walls; the first end wall and the second end wall both include a plurality of convex cylinders protruding therefrom opposite to each other; the embedding assembly includes a first sheet and a second sheet, the first sheet and the second sheet both define a plurality of through holes and are embedded into the corresponding first end wall and the second end wall respectively.

13. The method for manufacturing the housing for portable electronic device as claimed in claim 12, wherein the two side walls both includes a slot recessed therein opposite to each other, the bracket includes two opposite longitudinal lateral walls configured to be assembled and accommodated into the corresponding two slots of the two side walls.

14. The method for manufacturing the housing for portable electronic device as claimed in claim 13, wherein the two longitudinal lateral walls both defines two latching grooves therein spaced, each slot includes two latching hooks spaced protruding from a bottom wall thereof and configured for latching into the corresponding two latching groove of each longitudinal lateral wall.

15. The method for manufacturing the housing for portable electronic device as claimed in claim 14, wherein the bracket further includes a base wall and two opposite transverse walls, a notch is defined at the corner of the bracket corresponding to the gap of the first end wall, the two transverse walls are welded to the first sheet and second sheet respectively.

16. The method for manufacturing the housing for portable electronic device as claimed in claim 11, wherein the plastic material is selected from a group consisting of polyethylene, polyamide, polycarbonate composition, and acrylonitrile butadient styrene.
